(19) United States
(12) Patent Application Publication
(10) Pub. No.: US 2002/0199102 A1
(43) Pub. Date: Dec. 26, 2002

(54) Method and apparatus for establishing a shared cryptographic key between energy-limited nodes in a network

(76) Inventors: David W. Carman, Glenwood, MD (US); Brian J. Matt, Riva, MD (US)

Correspondence Address: PARK, VAUGHAN & FLEMING LLP, 508 SECOND STREET, SUITE 201, DAVIS, CA, 95616, US

(21) Appl. No.: 09/887,585

(22) Filed: Jun. 21, 2001

(51) Int. Cl. H04L 9/00

(52) U.S. Cl. 713/168

(57) ABSTRACT

One embodiment of the present invention provides a system for establishing a cryptographic key between energy-limited nodes using a super node that has abundant energy. The node also sends a message to a super node including the partial key value encrypted using the super node's a public key. Note that the energy-limited node only encrypts with the public key, which requires less energy than decrypting with the corresponding private key. The super node then decrypts to recover the partial key value. Next, the super node securely communicates the partial key value to the second node. The second node then establishes the cryptographic key using the first and second node's partial key values.

### BACKGROUND

1. Field of the Invention

The present invention relates to cryptographic keys. More specifically, the present invention relates to a method and an apparatus that facilitates reducing energy costs while establishing a shared cryptographic key between energy-limited nodes in a network.

2. Related Art

Users of modern networked systems routinely use cryptographic techniques when communicating with other systems to prevent disclosure of the contents of the communications and to authenticate the source of the communications. One of the hardest problems in using these cryptographic techniques is to establish a shared key to encrypt communications between nodes.

Conventional cryptographic mechanisms for key establishment either lack the required flexibility or are too expensive to use in wireless, resource-limited networks. In this context, expensive means that these key establishment mechanisms require excessive electrical energy, excessive time, excessive computing power, excessive bandwidth, or a combination of these along with other factors. Many acl-hoc networks facilitate wireless communications among participating fixed and mobile units without relying on existing infrastructure, such as the towers and landlines that make up the current cellular telephone systems or on satellites and ground stations.

Existing key establishment techniques rely either on public key cryptography or on symmetric key cryptography combined with special trusted devices called key distribution centers or key translation centers. The problem with standard public key based techniques is that they are expensive; requiring excessive energy, time, and computing power, particularly for private key decryption. The problem with symmetric key based techniques is that, while they are relatively efficient, they lack flexibility, resulting in excessive key management overhead and expensive updating of distributed databases over wireless communication channels.

What is needed is a method and an apparatus that facilitates establishing a shared cryptographic key between energy-limited nodes without the difficulties listed above.

### SUMMARY

One embodiment of the present invention provides a system for establishing a cryptographic key between energy-limited nodes using a super node that has abundant energy. The node also sends a message to a super node including the partial key value encrypted using the super node's public key. Note that the energy-limited node only encrypts with the public key, which requires less energy than decrypting with the corresponding private key. The super node then decrypts to recover the partial key value. Next, the super node securely communicates the partial key value to the second node. The second node then establishes the cryptographic key using the first and second node's partial key values.

In one embodiment of the present invention, a node sends a message authentication code that can authenticate a partial key value to a second node.

In one embodiment of the present invention, the second node authenticates the first node's partial key value using the message authentication code received previously.

In one embodiment of the present invention, the second node sends the partial key value encrypted using the public key to the super node. Next, the super node decrypts the partial key value. The super node then securely communicates this partial key value to the first node. The first node then establishes the cryptographic key using the first node's partial key value and the second node's partial key value.

In one embodiment of the present invention, the second node sends a message authentication code that can authenticate a partial key value to the first node.

In one embodiment of the present invention, the first node authenticates the second partial key value using the message authentication code received from the second node.

In one embodiment of the present invention, the super node securely communicates the first node's partial key value to the second node by encrypting the partial key value using a symmetric key provided by the second node. The super node then transmits this encrypted partial key value to the second node, and the second node decrypts the encrypted partial key value to recover the partial key value.

In one embodiment of the present invention, the super node validates the symmetric key provided by the second node using a certificate provided by a recognized certificate authority.

In one embodiment of the present invention, the certificate includes validation information for several symmetric keys. In this embodiment, a new second node symmetric key is selected periodically.

In one embodiment of the present invention, the symmetric key provided by the second node is saved at the super node so that a subsequent key establishment can use symmetric key encryption for encrypting the first node's partial key value.

In one embodiment of the present invention, the super node securely communicates the second node's partial key value to the first node by encrypting the partial key value using a symmetric key provided by the first node. The super node then transmits this encrypted partial key value to the first node. Next, the first node decrypts the encrypted partial key value to recover the partial key value.

In one embodiment of the present invention, the super node validates the symmetric key provided by the first node using a certificate provided by a recognized certificate authority.

In one embodiment of the present invention, the certificate includes validation information for several symmetric keys. A new first node symmetric key is selected periodically.

In one embodiment of the present invention, the symmetric key provided by the first node is saved at the super node so that a subsequent key establishment can use symmetric key encryption for encrypting the second node's partial key value.

In one embodiment of the present invention, establishing the cryptographic key at the first node involves creating a hash of the first node's partial key value and the second node's partial key value.

In one embodiment of the present invention, establishing the cryptographic key at the second node involves creating a hash of the first node's partial key value and the second node's partial key value.

In one embodiment of the present invention, the system establishes trust of the super node at the first node by validating a certificate provided by a recognized certificate authority and presented to the first node by the super node.

In one embodiment of the present invention, the system establishes trust of the super node at the second node by validating a certificate provided by a recognized certificate authority and presented to the second node by the super node.

### BRIEF DESCRIPTION OF THE FIGURES

FIG. 1 illustrates nodes coupled to super node 100 in accordance with an embodiment of the present invention.

FIG. 2 illustrates super node 100 in accordance with an embodiment of the present invention.

FIG. 3 illustrates node 110 in accordance with an embodiment of the present invention.

FIG. 4 illustrates node 120 in accordance with an embodiment of the present invention.

FIG. 5 is an activity diagram illustrating message flow related to time in accordance with an embodiment of the present invention.

FIG. 6 is a flowchart illustrating establishing a shared cryptographic key in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system.

This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

### Computing Nodes

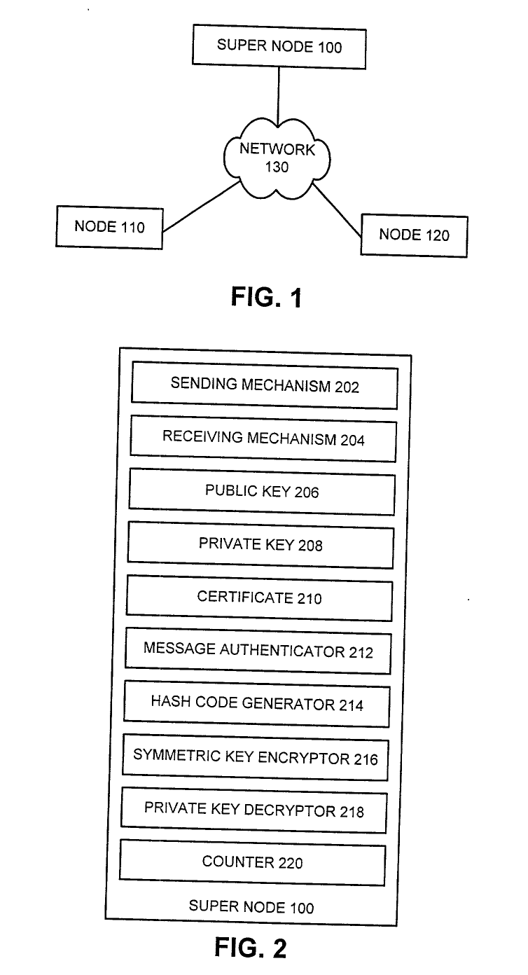

FIG. 1 illustrates nodes coupled to super node 100 in accordance with an embodiment of the present invention. Computing nodes 110 and 120 are coupled to super node 100 across network 130.

Super node 100 and nodes 110 and 120 can generally include any type of computer system, including, but not limited to, a computer system based on a microprocessor, a mainframe computer, a digital signal processor, a portable computing device, a personal organizer, a device controller, and a computational engine within an appliance. Super node 100 and nodes 110 and 120 can include mobile secure communication devices, which have embedded computer processors. In one embodiment of this invention, nodes 110 and 120 can be energy-limited while super node 100 has abundant energy. A practitioner with ordinary skill in the art will readily recognize that, while establishing a shared cryptographic key involves only one super node and two nodes, the system can include more than one super node and more than two nodes.

Network 130 can generally include any type of wire or wireless communication channel capable of coupling together nodes. This includes, but is not limited to, a local area network, a wide area network, or a combination of networks. In one embodiment of the present invention, network 130 includes a wireless communication network.

### Super Node 100

FIG. 2 illustrates super node 100 in accordance with an embodiment of the present invention. Super node 100 includes sending mechanism 202, receiving mechanism 204, public key 206, private key 208, certificate 210, message authenticator 212, hash code generator 214, symmetric key encryptor 216, private key decryptor 218, and counter 220.

Sending mechanism 202 provides the capability of sending messages from super node 100 to other nodes, for example nodes 110 and 120. Receiving mechanism 204 provides the capability of receiving messages at super node 100 from other nodes, for example nodes 110 and 120.

Public key 206 is available to the public as an encryption key for communicating with super node 100 and for authenticating messages from super node 100. The benefits of this invention are most pronounced when the public key algorithm selected for use in this invention has the property that the energy required for encryption is much less than the energy required for decryption. An example of a public key algorithm with this property is the well-known Rivest-Shamir-Adleman (RSA) algorithm.

Private key 208 is the private key that corresponds to public key 206. Private key 208 is used to decrypt values that have been encrypted using public key 206.

Certificate 210 is a certificate that has been signed by a certificate authority known to nodes 110 and 120. Well-known types of certificate that can be used include X.509 certificates and Pretty Good Privacy (PGP) certificates. Super node 100 can present certificate 210 to nodes 110 and 120 to establish the validity of super node 100.

Message authenticator 212 validates message authentication codes received with messages received by receiving mechanism 204. Message authenticator 212 also creates message authentication codes for messages being sent by sending mechanism 202.

Hash code generator 214 can use any available hash algorithm to create a hash code of the values presented to hash code generator 214. An example of a hash algorithm is secure hash algorithm one (SHA-1).

Symmetric key encryptor 216 performs encryption using any available symmetric key algorithm. Well-known examples of symmetric key encryption algorithms are Data Encryption Standard (DES), Triple DES, and Advanced Encryption Standard (AES).

Private key decryptor 218 performs decryption using the algorithm related to public key 206 and private key 208. Counter 220 is used to prevent a replay attack on the system. Counter 220 is incremented once for each message sent.

### Node 110

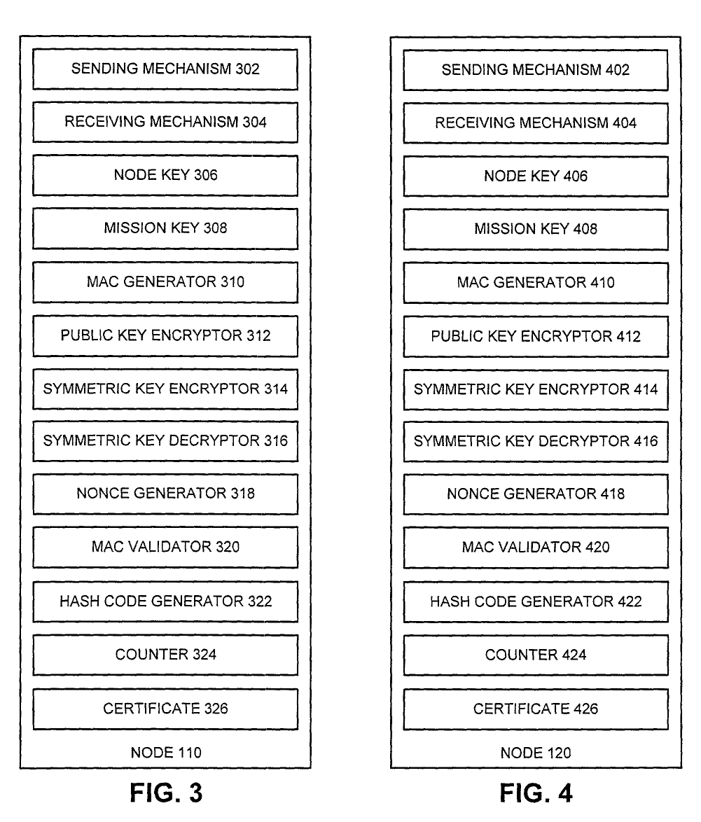

FIG. 3 illustrates node 110 in accordance with an embodiment of the present invention. Node 110 includes sending mechanism 302, receiving mechanism 304, node key 306, mission key 308, MAC generator 310, public key encryptor 312, symmetric key encryptor 314, symmetric key decryptor 316, nonce generator 318, MAC validator 320, hash code generator 322, counter 324, and certificate 326.

Sending mechanism 302 provides the capability of sending messages from node 110 to other nodes, for example node 120 and super node 100. Receiving mechanism 304 provides the capability of receiving messages at node 110 from other nodes, for example node 120 and super node 100.

Node key 306 is a symmetric key assigned to node 110 to provide encryption and authentication using the selected symmetric key encryption algorithm. The selected symmetric key encryption algorithm can include DES, Triple DES, and AES.

Mission key 308 is shared by all nodes to provide encryption and message authentication for communications among all nodes. Mission key 308 is also a symmetric key for the selected symmetric key encryption algorithm.

MAC generator 310 can generate message authentication codes for messages being sent from node 110. Typically, a message authentication code is created using a cryptographic process, which encrypts part of the message being sent using a block-chaining method and uses the output of the final round of chaining as the message authentication code.

Public key encryptor 312 uses the selected public key encryption algorithm to perform encryption of messages being sent to super node 100. The public key algorithm selected for use requires that the energy required for encryption is much less than the energy required for decryption. An example of a public key algorithm with this property is the well-known RSA algorithm.

Symmetric key encryptor 314 performs encryption using node key 306 and mission key 308. Symmetric key encryptor 314 uses the selected symmetric key encryption algorithm. Symmetric key decryptor 316 decrypts data encrypted using node key 306 and mission key 308.

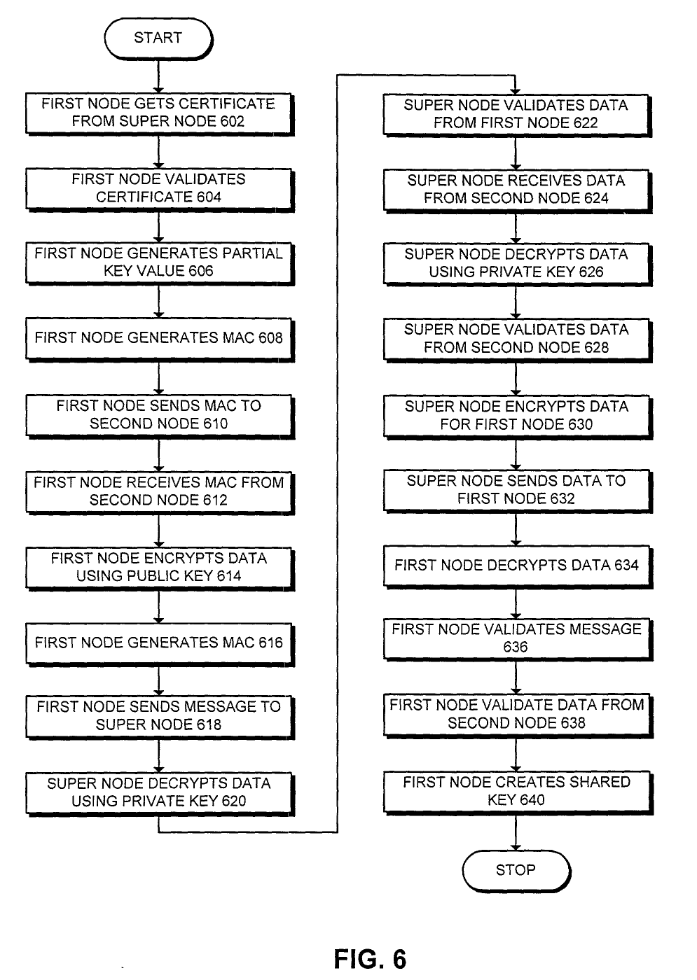

Nonce generator 318 generates random values called nonces, which can be used to generate a partial cryptographic key at node 110. The partial cryptographic keys are explained below in conjunction with FIG. 6. A nonce has a statistically low probability of being reused.

MAC validator 320 validates message authentication codes received in messages by receiving mechanism 304. MAC validator 320 ensures that the received message has not been changed during transmission to node 110.

Hash code generator 322 can use any available hash algorithm to create a hash code of the values presented to hash code generator 322. An example of a hash algorithm is secure hash algorithm one (SHA-1)

Counter 324 is used to prevent a replay attack on the system. Counter 324 is incremented once for each message sent.

Certificate 326 is a certificate that has been signed by a certificate authority known to super node 100. Well-known types of certificate that can be used include X.509 certificates and Pretty Good Privacy (PGP) certificates. A node, for example node 110, can present certificate 326 to super node 100 to establish the validity of node 110.

### Node 120

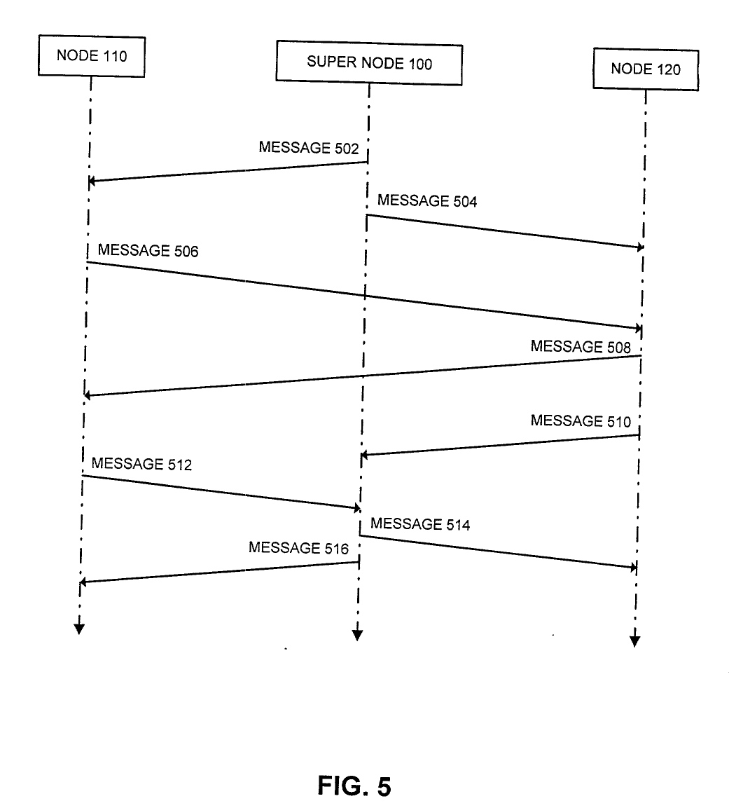

FIG. 4 illustrates node 120 in accordance with an embodiment of the present invention. Node 120 includes sending mechanism 402, receiving mechanism 404, node key 406, mission key 408, MAC generator 410, public key encryptor 412, symmetric key encryptor 414, symmetric key decryptor 416, nonce generator 418, MAC validator 420, hash code generator 422, counter 424, and certificate 426. Node 120 is symmetric with node 110, and any other node in the system. Details of the components within node 120 are as described for node 110 in conjunction with FIG. 3 above. Both nodes have been described to allow reference to both nodes in conjunction with the descriptions of FIGS. 5 and 6.

### Activity Diagram

FIG. 5 is an activity diagram illustrating message flow related to time in accordance with an embodiment of the present invention. In FIG. 5, the flow of time is from the top of the activity diagram to the bottom of the activity diagram. Note that since node 110 and node 120 are symmetric, either node can take on either role as described below. As will be obvious to a practitioner with ordinary skill in the art, the messages in FIG. 5 can be sent in an order different from what is shown. For example, message 506 can be sent after message 508 or both messages can be sent simultaneously. The order selected herein facilitates the explanation of FIG. 6.

The system starts when super node 120 sends message 502 to node 110 presenting certificate 210 to node 110. The contents of all messages described in conjunction with FIG. 5 are presented in the detailed discussion of FIG. 6. Certificate 210 has been signed by a certificate authority known to node 110 and is used by node 110 to validate super node 100. Details of validation using certificates are well known in the art and will not be described further herein.

Super node 100 sends message 504 to node 120 presenting certificate 210 to node 120. Certificate 210 has been signed by a certificate authority known also to node 120 and is used by node 120 to validate super node 100.

Node 110 sends message 506 to node 120. Message 506 includes a message authentication code, which can be used later to establish the validity of the partial key data received at node 120 from super node 100 on behalf of node 110. Details of this validation are discussed below in conjunction with FIG. 6.

Node 120 sends message 508 to node 110. Message 508 includes a message authentication code, which can be used later to establish the validity of the partial key data received at node 110 from super node 100 on behalf of node 120. Details of this validation are also discussed below in conjunction with FIG. 6.

Next, node 120 sends message 510 to super node 100. Message 510 includes node key 406 belonging to node 120, a message authentication code, and data so that super node 100 can create a partial key value to send to node 110 on behalf of node 120.

Node 110 sends message 512 to super node 100. Message 512 includes node key 306 belonging to node 110, a message authentication code, and data so that super node 100 can create a partial key value to send to node 120 on behalf of node 110.

Super node 100 then sends message 514 to node 120. Message 514 includes a partial key value on behalf of node 110 and a message authentication code for validating message 514. Node 120 uses the authentication code received in message 506 to validate the partial key value received in message 514. Node 120 uses the partial key value received in message 514 and a partial key value generated within node 120 to create a shared cryptographic key with node 110.

Super node 100 also sends message 516 to node 110. Message 516 includes a partial key value on behalf of node 120 and a message authentication code for validating message 516. Node 110 uses the authentication code received in message 508 to validate the partial key value received in message 516. Node 110 uses a partial key value generated within node 110 and the partial key value received in message 516 and to create a shared cryptographic key with node 120.

### Establishing the Shared Cryptographic Key

FIG. 6 is a flowchart illustrating establishing a shared cryptographic key in accordance with an embodiment of the present invention. FIG. 6 relates to establishing the shared cryptographic key at node 110. Since the steps required to establish the shared cryptographic key at node 120 are symmetric with the steps required to establish the shared cryptographic key at node 110, the steps required to establish the shared cryptographic key at node 120 will not be discussed herein.

The system starts when node 110 receives certificate 210 from super node 100 in message 502 (step 602). Note that node 110 can request certificate 210 from super node 100 to initiate the process. Node 110 validates certificate 210, and therefore the identity of super node 100, using well-known techniques associated with the type of certificate being used (step 604). Details of the validation of certificate 210 are not provided herein.

Next, node 110 generates a partial key value to be used to create a shared cryptographic key (step 606). The partial key value is: H(K_{A}∥N_{A}), where H( ) indicates a hash code generated by hash code generator 322, K_{A} is node key 306, N_{A} is a nonce generated by nonce generator 318, and ∥ indicates concatenation.

Node 110 generates a message authentication code that can be used later by node 120 to validate the partial key value received at node 120 from super node 100 on behalf of node 110 (step 608). The message authentication code includes: MAC(K_{M}, H(K_{A}∥N_{A})∥Msg∥Counter_{A} ∥ID_{A} ∥ID_{S}), where MACO indicates a message authentication code, K_{M} is mission key 308 and is the key used to create the message authentication code, MsgID is a message identifier, Counter_{A} is the value of counter 324, ID_{A} is an identifier for node 110, and ID_{S} is an identifier for super node 100. Counter 324 is incremented for each key establishment so that a replay attack can be detected.

Sending mechanism 302 within node 110 then sends the message authentication code to node 120 in message 506 (step 610). Message 506 includes:

MsgID∥E(K_{M}, Counter_{A}∥ID_{A}∥ID_{S)})∥MAC(K_{M}, MsgID∥Counter_{A}∥ID_{A}∥ID_{S)})∥MAC(K_{M}, H(K_{A}∥N_{A})∥MsgID∥Counter_{A}∥ID_{A}∥ID_{S}),

where E( ) indicates encryption. E(K_{M}, Counter_{A}∥ID_{A}∥ID_{S)}) provides all of the values used in creating MAC(K_{M}, H(K_{A}∥N_{A})∥MsgID∥Counter_{A}∥ID_{A}∥ID_{S}) with the exception of H(K_{A}∥N_{A}). When node 120 receives H(K_{A}∥N_{A}) from super node 100 on behalf of node 110, node 120 can validate H(K_{A}∥N_{A}) as authentic using MAC(K_{M}, H(K_{A}∥N_{A})∥MsgID∥Counter_{A}∥ID_{A}∥ID_{S}). MAC(K_{M}, MsgID∥Counter_{A}∥ID_{A}∥ID_{S)}) can be used by node 120 to authenticate message 506.

Receiving mechanism 304 within node 110 receives message 508 from node 120 (step 612). Message 508 includes:

MsgID∥E(K_{M}, Counter_{B}∥ID_{B}∥ID_{S)}) MAC(K_{M}, MsgID∥Counter_{B}∥ID_{B}∥ID_{S)}) MAC(K_{M}, H(K_{B}∥N_{B})∥MsgID∥Counter_{B}∥ID_{B}∥ID_{S}).

The format of message 508 is identical to the format of message 506. Counter_{B} is the value of counter 424, K_{B} is node key 406, N_{B} is a value created by nonce generator 418, and ID_{B} is the identifier of node 120.

Next, public key encryptor 312 encrypts Counter_{A}∥ID_{A}∥ID_{B}∥K_{A}∥N_{A} using public key 206, S_{PUB}, creating E(S_{PUB}, Counter_{A}∥ID_{A}∥ID_{B}∥K_{A}∥N_{A}) (step 614). MAC generator 310 generates MAC(K_{A}, MsgID∥Cert_{A}∥Counter_{A}∥ID_{A}∥ID_{B}∥N_{A}), where Cert_{A} is a certificate signed by a known certificate authority so that super node 100 can establish the validity of node 110 (step 616). Sending mechanism 302 then sends message 512 to super node 100 (step 618). Message 512 includes:

MsgID∥Cert_{A}∥E(S_{PUB}, Counter_{A}∥ID_{A}∥ID_{B}∥K_{A}∥N_{A})∥MAC(K_{A}, MsgID∥Cert_{A}∥Counter_{A}∥ID_{A}∥ID_{B}∥N_{A}).

When receiving mechanism 204 within super node 100 receives message 512, private key decryptor 218 decrypts E(S_{PUB}, Counter_{A}∥ID_{A}∥ID_{B}∥K_{A}∥N_{A}) using private key 208 to recover Counter_{A}∥ID_{A}∥ID_{B}∥K_{A}∥N_{A}(step 620). Next, message authenticator 212 validates message 512 using MAC(K_{A}, MsgID∥Cert_{A}∥Counter_{A}∥ID_{A}∥ID_{B}∥N_{A}) (step 622).

Receiving mechanism 204 within super node 100 also receives message 510 from node 120 (step 624). The format of message 510 is identical to the format of message 512 and includes:

MsgID∥Cert_{B}∥E(S_{PUB}, Counter_{B}∥ID_{B}∥ID_{A}∥K_{B}∥N_{B})∥MAC(K_{B}, MsgID∥Cert_{B}Counter_{B}∥ID_{B}∥ID_{A}∥N_{B}).

Private key decryptor 218 decrypts E(S_{PUB}, Counter_{B}ID_{B}∥ID_{A}∥K_{B}∥N_{B}) using private key 208 to recover Counter_{B}∥ID_{B}ID_{A}∥K_{B}∥N_{B} (step 626). Next, message authenticator 212 validates message 510 using MAC(K_{B}, MsgID∥Cert_{B}∥Counter_{B}∥ID_{B}∥ID_{A}∥N_{B}) (step 628).

Next, symmetric key encryptor 216 encrypts Counters_{SN}∥ID_{B}∥H(K_{B}∥N_{B}) using K_{A} creating E(K_{A}, Counter_{SN}∥ID_{B}∥H(K_{B}∥N_{B})) (step 630). Sending mechanism 202 then sends message 516 to node 110 (step 632). Message 516 includes:

MsgID∥E(K_{A}, Counter_{SN}∥ID_{B}∥H(K_{B}∥N_{B}))∥MAC(K_{A}, MsgID∥Counter_{SN}∥ID_{B}∥H(K_{B}∥N_{B})).

When receiving mechanism 304 within node 110 receives message 516, symmetric key decryptor 316 decrypts E(K_{A}, Counter_{SN}∥ID_{B}∥H(K_{B}∥N_{B})) recovering K_{A}, Counter_{SN}∥ID_{B}∥H(K_{B}∥N_{B})(step 634). Next, MAC validator 320 validates message 516 using MAC(K_{A}, MsgID∥Counter_{SN}∥ID_{B}∥H(K_{B}∥N_{B})) (step 636). To validate H(K_{B}∥N_{B}), MAC validator 320 uses MAC(K_{M}, H(K_{B}∥N_{B})∥MsgID∥Counter_{B}∥ID_{B}∥ID_{S}) received in message 508 (step 638).

Finally, hash code generator 322 generates H(H(K_{A}∥N_{A}), H(K_{B}∥N_{B})) which is the shared cryptographic key (step 640). Note that both node 110 and node 120 must generates H(H(K_{A}∥N_{A}), H(K_{B}∥N_{B}))to arrive at the same shared key.

### Amortized Keying

In one embodiment of the present invention, the system allows super node 100 to save key data received from nodes 110 and 120 during an initial exchange. Subsequently, super node 100 can use the saved key data to reduce both energy and communication costs. Except as noted below, the processing for key establishment using amortized keying is the same as described above in relation to FIG. 6.

In this embodiment, message 512 is modified for the initial exchange to include:

MsgID∥Cert_{A}∥E(S_{PUB}, Counter_{A}∥ID_{A}∥ID_{B}∥K_{A}∥N_{A}∥K_{A/s})∥MAC(K_{A}, MsgID∥Cert_{A}∥Counter_{A}∥ID_{A}∥ID_{B}N_{A}),

where K_{A/S} is a symmetric key that is saved at super node 100 for subsequent communication with node 110.

Message 510 is modified to include:

MsgID∥Cert_{B}∥E(S_{PUB}, Counter_{B}∥ID_{B}∥ID_{A}∥K_{B}∥N_{B}∥K_{B/S})∥MAC(K_{B}, MsgID∥Cert_{B}∥Counter_{B}∥ID_{B}∥ID_{A}∥N_{B}),

where K_{B/S} is a symmetric key that is saved at super node 100 for subsequent communication with node 120.

In subsequent exchanges in this embodiment, messages 502 and 504 are eliminated. In addition, message 512 becomes:

MsgID∥[Cert_{A}∥] E(K_{A/S}, Counter_{A}∥ID_{A}∥ID_{B}∥K_{A}∥N_{A})∥MAC(K_{A}, MsgID∥Cert_{A}∥Counter_{A}∥ID_{A}∥ID_{B}∥N_{A}),

and message 510 becomes:

MsgID∥[Cert_{B}∥] E(K_{B/S}, Counter_{B}∥ID_{B}ID_{A}∥K_{B}∥N_{B})∥MAC(K_{B}, MsgID∥Cert_{B}∥Counter_{B}∥ID_{B}∥ID_{A}∥N_{B}).

Note that in messages 512 and 510, Cert_{A} and Cert_{B}, respectively, are optional. Also note that in messages 512 and 510 the encryption is done using the less expensive symmetric key encryption.

### Enhanced Security

A security problem that occurs to varying degrees in both the standard protocol and the amortized protocol above is that both protocols require a node to divulge the node's secret key, Kᵢ, to the super node. A compromised super node can then impersonate that node to another super node using Kᵢ. One approach to prevent a compromised super node from impersonating a node is to provide symmetric keys for use between the node and the super node, which do not reveal the node's secret key, Kᵢ to the super node.

In this embodiment, a node hashes its node key several times to provide multiple key values. For example, node 110 can create H(H(H( . . . (H(K_{A})) . . . ))) and store the result in certificate 326. Then, K_{A} in messages 502 through 516 is replaced with H^{n-a}(K_{A}), where n is the number of times that K_{A} has been hashed and a represents the hash currently being used.

The value of a is synchronized between node 110 and super node 120 and is a monotonically increasing value to prevent reuse of a previously used value. Synchronization can be accomplished by establishing a reference time in Cert_{A} that specifies when a has a value of zero. The value of a is then incremented at regular, agreed-upon, intervals.

To be effective, n has to be sufficiently large so that a<n for the lifetime of node 110. To further reduce costs, H(K_{A}), H(H(K_{A})), H(H(H(K_{A}))), . . . , Hⁿ(K_{A}) can be store in a table within node 110 prior to deployment.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for establishing a cryptographic key for use between a first node and a second node using a super node, wherein the first node and the second node are energy-limited and the super node has abundant energy, the method comprising:
sending a first message from the first node to the super node, wherein the first message includes a first partial key value encrypted using a public key belonging to the super node, whereby encrypting with the public key requires less energy than decrypting with a private key corresponding to the public key;
recovering the first partial key value at the super node by decrypting using the private key;
securely communicating the first partial key value to the second node; and
establishing the cryptographic key at the second node using the first partial key value and a second partial key value created by the second node;
whereby energy usage is shifted to the super node by performing private key decryption at the super node.

2. The method of claim 1, further comprising sending a second message from the first node to the second node, wherein the second message includes a first message authentication code.

3. The method of claim 2, further comprising authenticating the first partial key value at the second node using the first message authentication code.

4. The method of claim 1, further comprising:
sending a third message from the second node to the super node, wherein the third message includes the second partial key value encrypted using the public key belonging to the super node;
recovering the second partial key value at the super node by decrypting using the private key;
securely communicating the second partial key value to the first node; and
establishing the cryptographic key at the first node using the first partial key value and the second partial key value.

5. The method of claim 4, further comprising sending a fourth message from the second node to the first node, wherein the fourth message includes a second message authentication code.

6. The method of claim 5, further comprising authenticating the second partial key value at the first node using the second message authentication code.

7. The method of claim 4, wherein securely communicating the first partial key value to the second node includes:
encrypting the first partial key value at the super node using a second node symmetric key creating a first encrypted partial key value, wherein the second node symmetric key is received in the third message;
transmitting the first encrypted partial key value to the second node; and
decrypting the first encrypted partial key value at the second node to recover the first partial key value.

8. The method of claim 7, wherein the second node symmetric key is validated using a certificate provided by a recognized certificate authority and wherein the certificate is included in the third message.

9. The method of claim 8, wherein the certificate includes validation information for a plurality of symmetric keys and wherein a new second node symmetric key is selected periodically from the plurality of symmetric keys.

10. The method of claim 7, wherein the second node symmetric key is saved at the super node so that a subsequent key establishment can use symmetric key encryption for encrypting the first partial key value.

11. The method of claim 4, wherein securely communicating the second partial key value to the first node includes:
encrypting the second partial key value at the super node using a first node symmetric key creating a second encrypted partial key value, wherein the first node symmetric key is received in the first message and wherein the first node symmetric key is encrypted using the public key belonging to the super node;
transmitting the second encrypted partial key value to the first node; and
decrypting the second encrypted partial key value at the first node to recover the second partial key value.

12. The method of claim 11, wherein the first node symmetric key is validated using a certificate provided by a recognized certificate authority and wherein the certificate is included in the first message.

13. The method of claim 12, wherein the certificate includes validation information for a plurality of symmetric keys and wherein a new first node symmetric key is selected periodically from the plurality of symmetric keys.

14. The method of claim 11, wherein the first node symmetric key is saved at the super node so that a subsequent key establishment can use symmetric key encryption for encrypting the second partial key value.

15. The method of claim 4, wherein establishing the cryptographic key at the first node involves creating a hash of the first partial key value and the second partial key value.

16. The method of claim 4, wherein establishing the cryptographic key at the second node involves creating a hash of the first partial key value and the second partial key value.

17. The method of claim 4, further comprising establishing trust of the super node at the first node by validating a certificate provided by a recognized certificate authority and presented to the first node by the super node.

18. The method of claim 4, further comprising establishing trust of the super node at the second node by validating a certificate provided by a recognized certificate authority and presented to the second node by the super node.

19. A computer-readable storage medium storing instructions that when executed by a computer cause the computer to perform a method for establishing a cryptographic key for use between a first node and a second node using a super node, wherein the first node and the second node are energy-limited and the super node has abundant energy, the method comprising:
sending a first message from the first node to the super node, wherein the first message includes a first partial key value encrypted using a public key belonging to the super node, whereby encrypting with the public key requires less energy than decrypting with a private key corresponding to the public key;
recovering the first partial key value at the super node by decrypting using the private key;
securely communicating the first partial key value to the second node; and
establishing the cryptographic key at the second node using the first partial key value and a second partial key value created by the second node;
whereby energy usage is shifted to the super node by performing private key decryption at the super node.

20. The computer-readable storage medium of claim 19, the method further comprising sending a second message from the first node to the second node, wherein the second message includes a first message authentication code.

21. The computer-readable storage medium of claim 20, the method further comprising authenticating the first partial key value at the second node using the first message authentication code.

22. The computer-readable storage medium of claim 19, the method further comprising:
sending a third message from the second node to the super node, wherein the third message includes the second partial key value encrypted using the public key belonging to the super node; recovering the second partial key value at the super node by decrypting using the private key;
securely communicating the second partial key value to the first node; and
establishing the cryptographic key at the first node using the first partial key value and the second partial key value.

23. The computer-readable storage medium of claim 22, the method further comprising sending a fourth message from the second node to the first node, wherein the fourth message includes a second message authentication code.

24. The computer-readable storage medium of claim 23, the method further comprising authenticating the second partial key value at the first node using the second message authentication code.

25. The computer-readable storage medium of claim 22, wherein securely communicating the first partial key value to the second node includes:
encrypting the first partial key value at the super node using a second node symmetric key creating a first encrypted partial key value, wherein the second node symmetric key is received in the third message;
transmitting the first encrypted partial key value to the second node; and
decrypting the first encrypted partial key value at the second node to recover the first partial key value.

26. The computer-readable storage medium of claim 25, wherein the second node symmetric key is validated using a certificate provided by a recognized certificate authority and wherein the certificate is included in the third message.

27. The computer-readable storage medium of claim 26, wherein the certificate includes validation information for a plurality of symmetric keys and wherein a new second node symmetric key is selected periodically from the plurality of symmetric keys.

28. The computer-readable storage medium of claim 25, wherein the second node symmetric key is saved at the super node so that a subsequent key establishment can use symmetric key encryption for encrypting the first partial key value.

29. The computer-readable storage medium of claim 22, wherein securely communicating the second partial key value to the first node includes:
encrypting the second partial key value at the super node using a first node symmetric key creating a second encrypted partial key value, wherein the first node symmetric key is received in the first message and wherein the first node symmetric key is encrypted using the public key belonging to the super node;
transmitting the second encrypted partial key value to the first node; and
decrypting the second encrypted partial key value at the first node to recover the second partial key value.

30. The computer-readable storage medium of claim 29, wherein the first node symmetric key is validated using a certificate provided by a recognized certificate authority and wherein the certificate is included in the first message.

31. The computer-readable storage medium of claim 30, wherein the certificate includes validation information for a plurality of symmetric keys and wherein a new first node symmetric key is selected periodically from the plurality of symmetric keys.

32. The computer-readable storage medium of claim 29, wherein the first node symmetric key is saved at the super node so that a subsequent key establishment can use symmetric key encryption for encrypting the second partial key value.

33. The computer-readable storage medium of claim 22, wherein establishing the cryptographic key at the first node involves creating a hash of the first partial key value and the second partial key value.

34. The computer-readable storage medium of claim 22, wherein establishing the cryptographic key at the second node involves creating a hash of the first partial key value and the second partial key value.

35. The computer-readable storage medium of claim 22, the method further comprising establishing trust of the super node at the first node by validating a certificate provided by a recognized certificate authority and presented to the first node by the super node.

36. The computer-readable storage medium of claim 22, the method further comprising establishing trust of the super node at the second node by validating a certificate provided by a recognized certificate authority and presented to the second node by the super node.

37. An apparatus that facilitates establishing a cryptographic key for use between a first node and a second node using a super node, wherein the first node and the second node are energy-limited and the super node has abundant energy, the apparatus comprising:
a first sending mechanism configured to send a first message from the first node to the second node, wherein the first message includes a first message authentication code;
the first sending mechanism further configured to send a second message from the first node to the super node, wherein the second message includes a first partial key value encrypted using a public key belonging to the super node, whereby encrypting with the public key requires less energy than decrypting with a private key corresponding to the public key;
a decrypting mechanism configured to recover the first partial key value at the super node by decrypting using the private key;
a secure communication mechanism configured to securely communicate the first partial key value to the second node;
a first authenticating mechanism configured to authenticate the first partial key value at the second node using the first message authentication code; and
a first establishing mechanism configured to establish the cryptographic key at the second node using the first partial key value and a second partial key value created by the second node.

38. The apparatus of claim 37, further comprising:
a second sending mechanism configured to send a third message from the second node to the first node, wherein the third message includes a second message authentication code;
the second sending mechanism further configured to send a fourth message from the second node to the super node, wherein the fourth message includes the second partial key value encrypted using the public key belonging to the super node;
the decrypting mechanism further configured to recover the second partial key value at the super node by decrypting using the private key;
the secure communication mechanism further configured to securely communicating the second partial key value to the first node;
a second authenticating mechanism configured to authenticate the second partial key value at the first node using the second message authentication code; and
a second establishing mechanism configured to establish the cryptographic key at the first node using the first partial key value and the second partial key value.
